(19) United States
(12) Patent Application Publication
(10) Pub. No.: US 2023/0091227 A1
(43) Pub. Date: Mar. 23, 2023

(54) CONSENSUS-LESS CROSS-CHAIN MESSAGE PASSING WITHOUT CENTRAL ENTITY

(71) Applicant: ToposWare Inc., Cambridge, MA (US)

(72) Inventors: Theo Kevin Gauthier, Cambridge, MA (US); Sebastien Paul-Edouard Thomas Dan, Cambridge, MA (US); Monir Hadji, Cambridge, MA (US)

(21) Appl. No.: 17/946,308

(22) Filed: Sep. 16, 2022

Related U.S. Application Data
(60) Provisional application No. 63/245,781, filed on Sep. 17, 2021.

(51) Int. Cl. H04L 9/32; H04L 67/104

(52) U.S. Cl. CPC H04L 9/3268; H04L 9/3236; H04L 67/1044

(57) ABSTRACT

Disclosed is a configuration for execution of a cross-chain protocol. The configuration receives, from a subnetwork of a plurality of subnetworks, a certificate comprising a plurality of dependencies specifying a substantially causal ordering of the certificate. The configuration applies the certificate and the plurality of dependencies of the certificate to a certificate digest. The configuration broadcasts a message to a peer-to-peer network communicatively linked to the plurality of subnetworks using a broadcast primitive. The message comprises the certificate and the certificate digest. The configuration compares the plurality of dependencies of the certificate in the certificate digest to a plurality of dependencies of the certificate in a certificate history. The configuration validates the certificate based on the comparison, and, applies the certificate digest to the certificate history based on the validation.

### CROSS REFERENCE TO RELATED APPLICATIONS

This application claims the benefit of U.S. Provisional Application 63/245,781 filed on Sep. 17, 2021, which is herein incorporated by reference in its entirety.

### BACKGROUND

An inherent problem in some blockchain systems is the challenge in allowing two or more independent blockchains to interoperate with each other. For example, it might be beneficial to allow two blockchains to perform cross-chain transactions (e.g., transferring assets such as coins between the two blockchains). Some early solutions for allowing the interoperability between blockchains relied on the blockchains to have a certain degree of trust among them, or relied on the blockchains having to reveal private information to allow third parties to interact with them. For example, in some systems, to allow for the interaction between two blockchains, the blockchains may communicate with an entity that is trusted by both entities which is then able to facilitate the transaction between the two blockchains. None of these solutions, however, are suitable when there is no such entity that the blockchains trust that can act as the intermediary. Moreover, in some scenarios, revealing private information to allow other entities to interact with the blockchain might not be desirable. As such, there is a need for a protocol that allows for the interoperability of blockchains that does not rely on a level of trust among two or more entities, and does not rely on the disclosure of private information.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 illustrates a block diagram of a system environment in which multiple blockchains operate, according to one or more embodiments.

FIG. 2 illustrates a block diagram of a local node participating in a cross-chain protocol, according to one or more embodiments.

FIG. 3 illustrate a flow diagram of a process in which a first subnetwork communicates information to a second subnetwork, according to one or more embodiments.

FIG. 4 illustrates a flowchart of a method of executing a cross-chain protocol, according to one or more embodiments.

FIG. 5 illustrates one embodiment of components of an example machine able to read instructions from a machine-readable medium and execute them in a processor (or controller).

### DETAILED DESCRIPTION

The Figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Embodiments provide an open interoperability protocol designed to reduce as much as possible trust assumptions by replacing them with cryptographic constructions and decentralization while exhibiting massive scalability. In embodiments, the cross-chain protocol described herein may not require a central blockchain or require consensus for consistent delivery of messages across a heterogeneous ecosystem of public and private blockchains, named subnetworks. Instead, in embodiments, the cross-chain protocol may rely on a weak causal reliable broadcast implemented by a peer-to-peer network or other distributed network, referred to herein as a “Transmission Control Engine” or “TCE.” The validity of cross-chain (i.e., interoperable across separate and different subnetworks) messages is ensured by the Universal Certificate Interface (UCI). In one embodiment, the validation of cross-chain messages comprises a proof (e.g., zkSTARK proof) asserting the validity of subnetwork state transitions. Such proofs of computational integrity are publicly verifiable by any other participants in and out the protocol such as other subnetworks or audit companies. In one embodiment, the interface between the TCE and subnetworks execute the ICE-FROST threshold signature scheme, where a static public key allows for uniquely identifying subnetworks after they register in the cross-chain protocol. In one embodiment, the cross-chain protocol may comprise the Topos protocol. Embodiments are configured to provide uniform security to a blockchain ecosystem and to handle several different types of subnetworks (e.g., permissioned and permissionless).

### System Architecture

Figure (FIG. 1 illustrates a block diagram of a system environment 100 in which multiple blockchains participate in a cross-chain protocol, according to one or more embodiments. As used herein, “participating in a cross-chain protocol,” “executing a cross-chain protocol,” and “performing a cross-chain protocol” may be used interchangeably. A “cross-chain protocol” is a network protocol that is interoperable between separate and different blockchain networks.

The system environment 100 comprises transmission control engine (TCE) nodes 124 and a plurality of subnetworks 120, including first subnetwork 120I, second subnetwork 120I, and third subnetwork 120R. As used herein, a “subnetwork” or “subnet” may refer to a blockchain network participating in a cross-chain protocol with other blockchain networks that are separate and different. Although the example of FIG. 1 shows three subnetworks 120, it is understood that the system environment 100 may include any number of subnetworks 120. TCE nodes 124 are processing nodes of a transmission control engine (TCE), which may be a “sidechain,” “offchain,” or “off blockchain” peer-to-peer processing network or other distributed network.

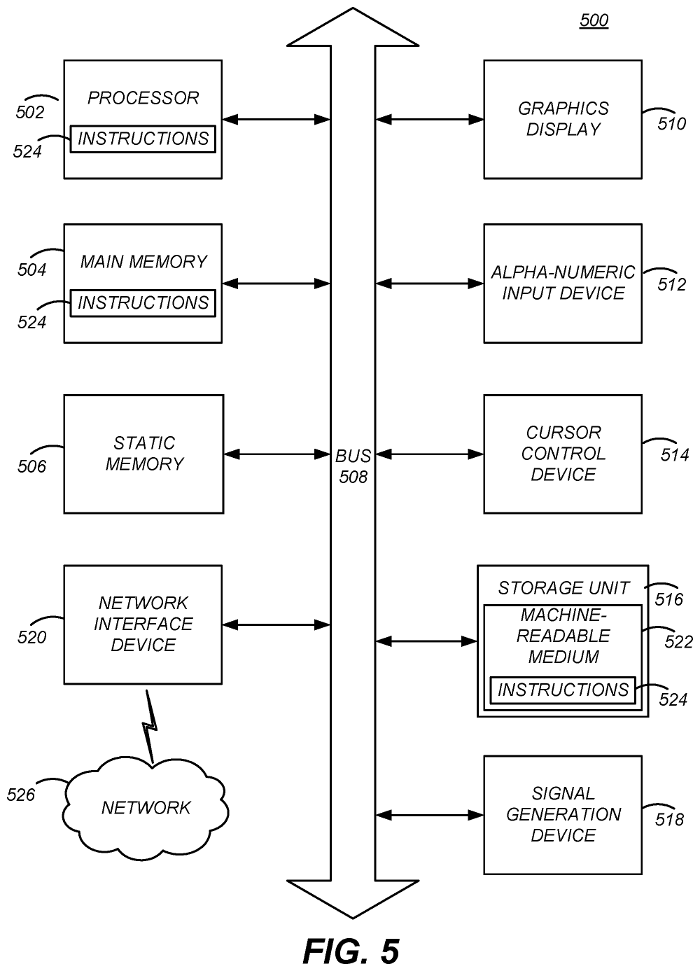

The plurality of subnetworks 120 may be communicatively linked with the TCE nodes 124. In embodiments, the subnetworks 120 may be in communication with the TCE nodes 124 via network connections between the TCE nodes 124 and the nodes 121 belonging to each of the respective subnetworks 120. For example, one or more node(s) 121J, 121I, and 121R may belong to the first subnetwork 120J, the second subnetwork 120I, and the third subnetwork 120R respectively. Each of the TCE nodes 124 and nodes 121 may be computing devices, such as desktop computers, laptop computers, mobile devices (e.g., smart phones, wearables, tablets, handheld device, other portable or movable device, etc.), internet-of-things (IOT) device, other device comprising a processor and memory. An example of a computing device and its components are described with respect to computer system 500 of FIG. 5, further below.

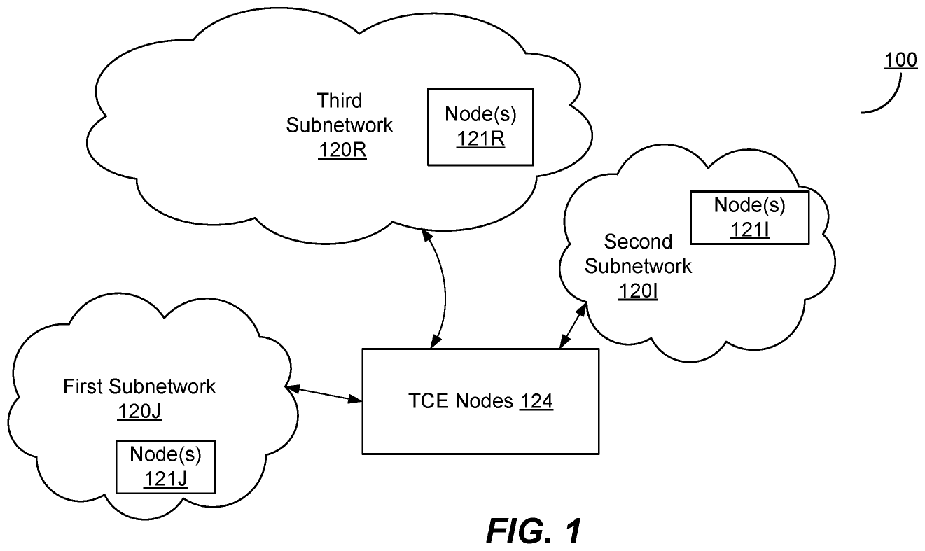

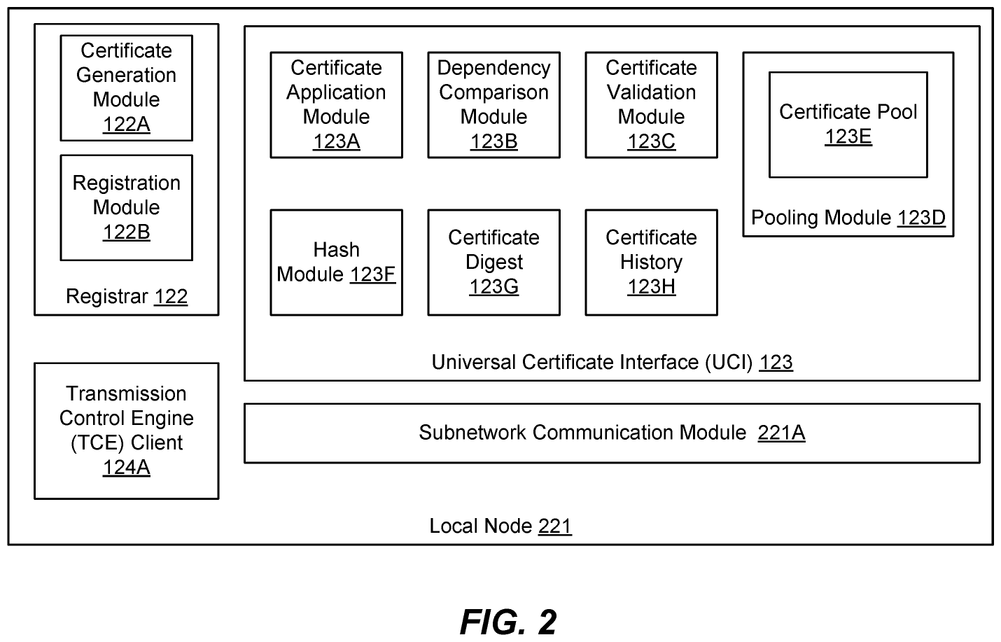

In one embodiment, one or more of the subnetworks 120 (e.g., the third subnetwork 120R) may be a registration subnetwork. As used herein, a “registration subnetwork” may refer to a subnetwork tasked with registering other subnetworks participating in a cross-chain protocol. In embodiments, the registration subnetwork is further configured to register nodes (e.g., any of nodes 121J or 121I) as TCE nodes 124, such as by provisioning the nodes with executable instructions to perform the functions, process, and methods of FIGS. 2, 3, and 4, as described in greater detail below. An example of a registration subnetwork is the Topos Subnet.

FIG. 2 illustrates a block diagram of a local node participating in a cross-chain protocol, according to one or more embodiments. The local node 221 may be any of the TCE nodes 124 or nodes 121 of system environment 100 (e.g., node(s) 121J, 121I, 121R), or some combination thereof. The local node 221 may comprise a subnetwork communication module 221A, a registrar 122, a universal certificate-interface (UCI) 123, and a transmission control engine (TCE) client 124A. In embodiments, the subnetwork communication module 221A, registrar 122, UCI 123, and TCE 124 may be implemented as computer-executable instructions stored on one or more computer readable storage mediums of the local node 221.

The subnetwork communication module 221A communicates with one or more subnetworks or one or more nodes thereof. In embodiments, the subnetwork communication module receives from the one or more subnetworks one or more certificates. The one or more certificates comprise a plurality of dependencies specifying a substantially causal ordering of the certificate.

The registrar 122 generates, maintains, and manages identifiers utilized in the execution of the cross-chain protocol. For example, the registrar 122 generates, maintains, manages unique identifiers, such as public and private keys, certificates, other device/network identifiers, and associations between the public and private keys, certificates, and/or other device/network identifiers. The registrar 122 comprises a certificate generation module 122A and registration module 122B.

Certificate generation module 122A generates certificates for use in the cross-chain protocol. As used herein, a “certificate” may refer to a data object that certifies an associated message, state transition, or other action or data relating to an entity when the certificate for the entity is validated. For example, a certificate may certify a state transition of a subnetwork 120, which is communicated to other entities (e.g., other subnetworks 120) once validated. By proving the validity of the certificate, the subnetwork 120 proves the validity of its internal transactions or other interactions, which may include interactions with separate and different subnetworks 120 (e.g., cross-chain transactions) that were executed since the previously submitted (e.g., last validated) certificate.

In embodiments, the certificates generated by certificate generation module 122A may comprise a plurality of dependencies specifying a substantially causal ordering of the certificates. A “causal ordering” may be an order of execution of actions that are causally linked or an ordering of data objects based on an order of causally linked actions performed on the data objects. For example, a causal ordering of the certificates generated by certificate generation module 122A may be an ordering of the certificate based on its dependencies and the dependencies of other certificates that depend on the certificate (e.g., the order that each certificate is to be delivered in a relational sequence). The causal ordering may be a relative ordering, where the ordering of one certificate is defined according to its relation to another, rather than its exact ordering in sequence. For example, rather than the causal ordering of certificate “D” being defined as coming after certificates “A,” “B,” and “C,” the causal ordering for certificate D may be defined as coming either before or after certificate “C.” A causal ordering can be a “weak causal ordering” or “pseudo-causal ordering,” in which the causal ordering is not strictly enforced. Furthermore, the weak causal ordering may be a “weak causal probabilistic reliable” ordering, in which the causal ordering is not strictly enforced, but has a high probability of being obeyed. In embodiments, the causal ordering of a certificate of a subnetwork 120 may comprise a hash of a previous state committed to by the subnetwork 120 and a hash of a new state of the subnetwork 120 that is committed to as a result of a state transition effected by the certificate.

The registration module 122B registers nodes into the cross-chain protocol. For example, the registration module 122B may comprise adding identifiers for the TCE nodes 124 and for the subnetworks 120 and/or nodes 121 thereof, to a registry that is maintained at the local node 221 or at a database or storage device accessible by the node 121 and/or coupled thereto. A node that is registered into the cross-chain protocol may be configured according to predefined rules upon registration by the registration module 122B.

Universal certificate-interface (UCI) 123 is a program interface for exchanging certificates between subnetworks executing the cross-chain protocol. The UCI 123 comprises a certificate application module 123A, a dependency comparison module 123B, a certificate validation module 123C, a pooling module 123D, a certificate pool 123E, a hash module 123F, a certificate digest 123G, and a certificate history 123H.

Certificate application module 123A applies certificates to stores of data, such as to a database. For example, certificate application module 123A may update a local copy of a distributed database stored on the local node 221. In embodiments, the local copy of the distributed database may comprise a local copy of certificate digest 123G and certificate history 123H described in greater detail below. In one embodiment, the distributed database may comprise a blockchain. As such, applying a certificate to the local copy of the certificate digest 123G and the certificate history 123H updates the local state of the local node 221.

In embodiments, the certificate application module 123A applies the certificate and its associated dependencies to the certificate digest 123G containing new state transitions for a subnetwork 120. The certificate application module 123A may further apply the certificate digest 123G containing the new state transitions of the subnetwork 120 to the certificate history 123H containing the previous states in response to the validation performed by the certification validation module 123C. The node 221 may then propagate the message to TCE nodes 124, which may be communicatively linked to nodes 121 of subnetworks 120 and may deliver the valid certificates and their underlying state transitions.

Dependency comparison module 123B compares dependencies of a certificate to a local copy of a distributed database. In one embodiment, dependency comparison module 123B compares the dependencies of a certificate to the certificate history 123H. For example, the dependency comparison module 123B may determine if there is a match between the dependencies of the certificate in the certificate digest 123G and the causal order of certificates stored in the certificate history 123H (i.e., the comparison result). The comparison result is used to validate the certificate.

Certificate validation module 123C validates certificates based on comparisons of dependency comparison module 123B. For example, if the comparison result indicates a match between the dependencies of a certificate in the certificate digest 123G and the causal order of certificates in the certificate history 123H, the certificate may be deemed valid.

Pooling module 123D pools certificates pending validation by the node 121. Pooling module 123D pools the certificates pending validation (referred to herein as “pending certificates”) into certificate pool 123E. The certificate pool 123E is a pool or set of pending certificates stored locally on the node 121. In some embodiments, pooling module 123D may pool the pending certificates prior to the pending certificates being processed by the dependency comparison module 123B and the certificate validation module 123C (i.e., prior to comparing the certificate's dependencies and validating).

Hash module 123F hashes data and stores the hashed data. In embodiments, hash module 123F hashes the certificates in the certificate history 123H and stores the hashes in a distributed database. In embodiments, hash module 123F hashes the certificates in the certificate digest 123G and stores the hashes in a distributed database.

Certificate digest 123G is a history or list of certificates associated with incoming messages to node 221. For each subnetwork 120 delineated in the certificate digest 123G, the certificate digest 123G may comprise a local set of incoming certificates involving said subnetwork 120 since the subnetwork's last successfully validated certificate (e.g., last accepted state transition). For example, a certificate digest 123G stored on node 121J may comprise records of certificates for transactions that have been conducted at the first subnetwork 120J, but that have not yet been validated by the second subnetwork 120J or third subnetwork 120R. Similarly, a certificate digest 123G stored on node 121I may comprise records of certificates for transactions that have been conducted at the first subnetwork 120J, but that have not yet been validated by the second subnetwork 120I or third subnetwork 120R.

Certificate history 123H is a history or list of certificates accepted/validated by nodes 121 participating in the cross-chain protocol (e.g., nodes 121J, 121I, and 121R). For each subnetwork 120 delineated in the certificate history 123H, the certificate history 123H may comprise a local set of accepted certificates involving said subnetwork 120, or hashes thereof, including for outgoing messages to the local node 121, incoming messages to the local node 121, or some combination thereof.

Transmission control engine (TCE) client 124A is distributed program for controlling transmission of certificates. For example, the TCE client 124A may be configured to resolve conflicts and prevent double-spend on one or more blockchains. In embodiments, the TCE client 124A may be running on multiple nodes communicating with the subnetworks participating in the cross-chain protocol (e.g., multiple TCE nodes 124 and/or multiple nodes 121). The TCE client 124A may control transmission of certificates according to a broadcast primitive. As used herein, a “broadcast primitive” may refer to one or more processes for controlling broadcasts in a network. In embodiments, the TCE client 124A is configured to broadcast messages to a peer-to-peer network (e.g., the TCE) communicatively linked to the plurality of subnetworks using the broadcast primitive, including messages comprising certificates and certificate digests. In embodiments, the broadcasted messages may comprise a certificate from an associated subnetwork 120 and the certificate digest 123G of the associated subnetwork 120 (e.g., as locally stored on a node 121 belonging to the subnetwork 120).

In embodiments, the broadcast primitive used by the TCE client 124A may be a probablistic broadcast primitive. As used herein, a “probabilistic broadcast primitive” may refer to a broadcast primitive that uses one or more probabilistic processes to increase reliability of broadcasts in a network. In embodiments, the probablistic processes may comprise byzantine processes. An example of a probabilistic broadcast primitive may be a “double-echo protocol” or “echo messaging protocol.” In one embodiment, the probablistic broadcast primitive may comprise a “weak causal probablistic reliable broadcast” as described in arXiv:2206.03481 “Topos: A Secure, Trustless, and Decentralized Interoperability Protocol” submitted Jun. 7, 2022 by Gauthier et al., which is herein incorporated by reference in its entirety.

In embodiments, a probablisitic broadcast primitive used by the TCE client 124A may comprise echo messaging. As used herein, “echo messaging” may refer to a message propagation scheme in which two or more samples of a message are created for each message that is to be propagated. The sampling may be probabilistic or stochastic. In embodiments, an echo message may be a subscription message. Echo messages may be associated with a sample type. In embodiments, sample types may include “echo,” “ready,” and “delivery” samples. Each of the sample types may indicate a sequential phase of communication exchanges between the subnetworks 120 of the cross-chain protocol. In embodiments, when the TCE client 124A initializes the broadcast primitive, TCE client 124A randomly samples a number of samples (i.e., sample size) from each sample type (e.g., “echo,” “ready,” and “delivery”). The local node 221 is configured to listen for messages coming from nodes associated with the samples. As such, the local node 221 need not know all of the TCE nodes 124 executing the cross-chain protocol, thereby enabling dynamic participation to the cross-chain protocol. Each sample type may be associated with a sample size and a threshold, which may be configured according to established security parameters. After initialization, the local node 221 has a sample size number of samples associated with each sample type and a threshold associated with each sample type. Upon receiving sample-specific subscription/echo messages from other subnetworks 120 participating in the cross-chain protocol, the local node 221 adds the corresponding message transmitter (e.g., identifier for the transmitting node) to a transmission set. The local node 221 is then configured to transmit messages to the nodes in the transmission set.

In embodiments, various computing devices (e.g. nodes 221) of system environment 100 can communicate directly with each other or broadcast messages using a probabilistic broadcast primitive, which in some instances may involve conflicting copies of a message (e.g., double-spend). Upon directly transmitting a signed message, the local node 221 transmits an echo message to the nodes in its transmission set. The local node 221 is further configured to send an echo message if it receives a threshold number of echo messages, in accordance with the threshold that is set for the sample type. For example, an “echo type” may be associated with a first threshold that may be different from a second threshold that is set for a “ready type” subscription/echo message. Furthermore, a third threshold may be a delivery threshold, where receiving a number of echo messages above the third threshold triggers direct transmission of the message to its intended receiver.

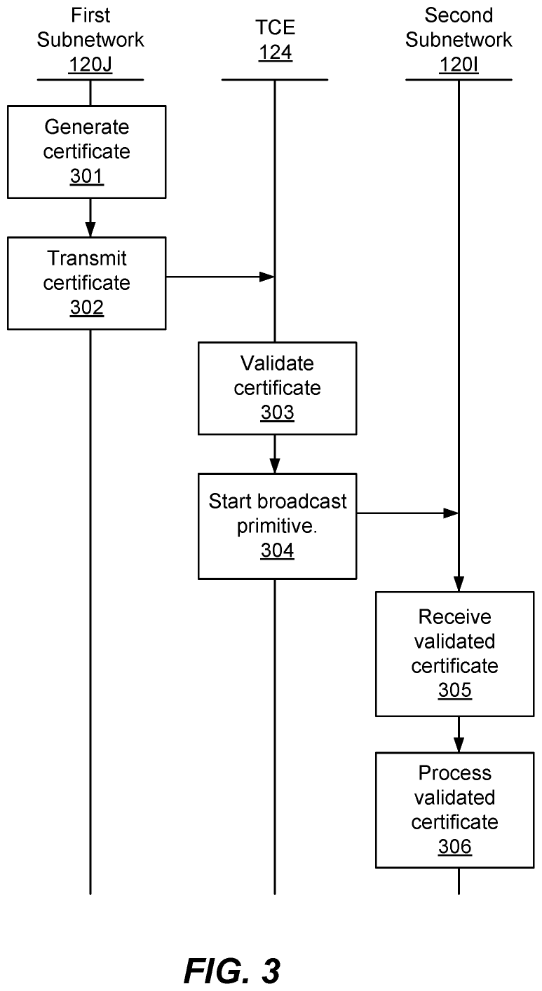

FIG. 3 illustrate a flow diagram of a process in which a first subnetwork communicates information to a second subnetwork, according to one or more embodiments. The process of FIG. 3 may be executed by a processor (one or more processors) of a computing device (e.g., node 221) as computer-executable instructions stored on a computer readable storage medium (one ore more) of the computing device.

The first subnetwork 120I generates 301 a certificate. For example, node 121I generates a certificate and applies the certificate to a local copy of its certificate digest 123G.

The first subnetwork 120I transmits 302 the certificate to a TCE node 124. For example, the node 121I transmits the certificate to a TCE node 124 that it has established a network communication link with.

The TCE node 124 validates 303 the certificate. For example, the TCE node 124 compares the dependencies of the certificate in a certificate digest 123G to a local copy of the certificate history 123H or the dependencies of the certificates contained therein (e.g., the hashes of the associated state transitions for previously submitted certificates from the first subnetwork 120J). If the dependencies of the certificate in the certificate digest 123G match the causal order of certificates in the certificate history 123H, the TCE node 124 may validate the certificate.

The TCE node 124 starts 304 a broadcast primitive. In one embodiment, the broadcast primitive may be a probablistic broadcast primitive. In one embodiment, the broadcast primitive may be a double-echo protocol. In one embodiment, the broadcast primitive may comprise a weak causal probablistic reliable broadcast. The TCE node 124 may construct a message comprising the validated certificate for delivery.

The second subnetwork 120I receives 305 the validated certificate. The validated certificate may be the certificate that was delivered by the TCE using the broadcast primitive.

The second subnetwork 120I processes 306 the validated certificate. The second subnetwork 120I accepts the validated certificate on-chain so that it is made available to the other subnetworks 120 of the system environment 100. As such, interactions such as new state transitions of the first subnetwork 120J are communicated to, and accepted by, the second subnetwork 120I, including internal transactions, cross-chain transactions, or some combination thereof.

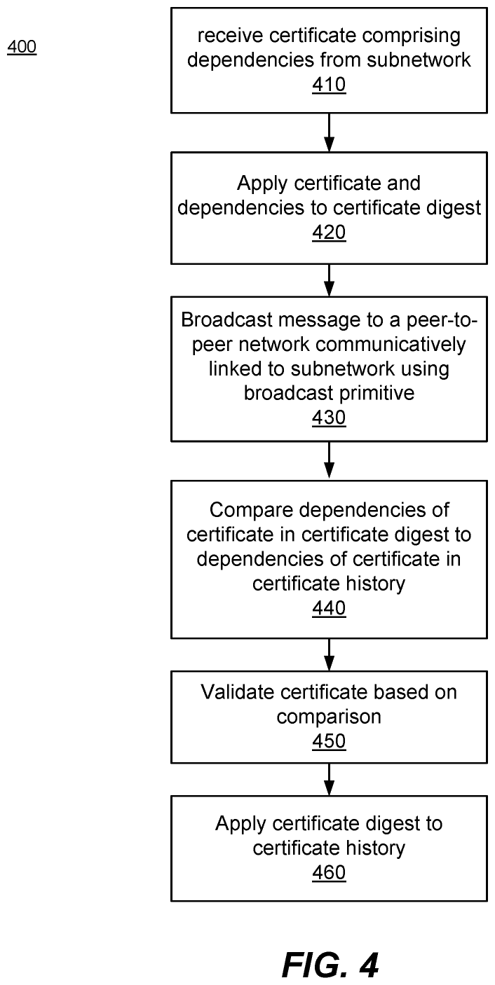

FIG. 4 illustrates a flowchart of a method of performing a cross-chain protocol, according to one or more embodiments. The process of FIG. 4 may be executed by one or more processors of a computing device (e.g., local node 221) as computer-executable instructions stored on one or more computer readable storage mediums of the computing device. For simplicity of describing the one or more embodiments, the method 400 is described with respect to instructions executed by a processor of a node of TCE nodes 124.

The processor receives a certificate from a subnetwork of a plurality of subnetworks. For example, a TCE node 124 receives a certificate associated with a subnetwork 120 from a node 121 of the subnetwork 120 that it is in communication with for validation. The certificate may comprise a plurality of dependencies specifying a substantially causal ordering of the certificate. For example, the dependencies may indicate previous states of the subnetwork 120 that were committed to in previously submitted certificates of the subnetwork 120. The certificate that is received by the TCE node 124 for validation communicates a new state, which may be a state transition that is applied to the previous states that were accepted.

The processor applies 420 the certificate and dependencies thereof to a certificate digest. For example, the TCE node 124 may add the certificate to its list of incoming certificates for the subnetwork 120 since the last validated state transitions for the subnetwork 120.

The processor broadcasts 430 a message to a peer-to-peer network that is communicatively linked to one or more subnetworks 120 using a broadcast primitive. The message may comprise the certificate and the certificate digest of the subnetwork 120 that submitted the certificate. The broadcast primitive may comprise a weak causal probablistic reliable broadcast, as previously mentioned.

The processor compares 440 the dependencies of the certificate in the certificate digest to dependencies of the certificate in the certificate history. For example, a TCE node 124 that receives the message comprising the certificate and certificate digest may compare the states committed to and applied in the certificate digest to the previous states committed to, as recorded in the certificate history. If the commitments are in agreement (e.g., causal order is substantially matched), then the certificate and its underlying state transitions may be authentic and valid.

The processor validates 450 the certificate. The validation 450 may be based on the comparison 440. For example, if the dependencies of the certificate outlined in the certificate digest match the causal order of the certificates in the certificate history for the subnetwork 120, the certificate may be deemed valid.

The processor applies 460 the certificate digest to the certificate history based on the validation. For example, the TCE node 124 may apply the certificate digest containing the new state transitions of the subnetwork to the certificate history 123H containing the previous states already deemed valid. The TCE node 124 may then propagate the message to other TCE nodes 124, which are communicatively linked to other subnetworks 120 and may deliver the valid certificates and their underlying state transitions. As such, certificates of the cross-chain network may be authenticated across subnetworks 120, thereby allowing for secure messaging and transacting across separate and different blockchain networks.

Embodiments described herein provide several technical advantages. By using a TCE to validate a certificate based on a comparison of new states conveyed through dependencies in a certificate digest to previous state commitments conveyed in a certificate history, blockchain interactions can be authenticated across separate and different blockchain networks in a consensus-less manner. By broadcasting the message using a broadcast primitive, such as through the use of a weak causal probablistic reliable broadcast, the consensus-less cross-chain protocol avoids double-spending in an asynchronous manner, and is therefore more secure than other protocols.

### Computing Machine Architecture

FIG. 5 is a block diagram illustrating components of an example machine able to read instructions from a machine-readable medium and execute them in a processor (or controller). Specifically, FIG. 5 shows a diagrammatic representation of a machine in the example form of a computer system 500 within which instructions 524 (e.g., software) for causing the machine to perform any one or more of the methodologies and/or functions described with FIGS. 1 through 4. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include graphics display unit 510 (e.g., a plasma display panel (PDP), a liquid crystal display (LCD), a projector, or a cathode ray tube (CRT)). The computer system 500 may also include alphanumeric input device 512 (e.g., a keyboard), a cursor control device 514 (e.g., a mouse, a trackball, a joystick, a motion sensor, or other pointing instrument), a storage unit 516, a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network 526 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method of executing a cross-chain protocol, the method comprising:
receiving, from a subnetwork of a plurality of subnetworks a certificate comprising a plurality of dependencies specifying a substantially causal ordering of the certificate;
applying the certificate and the plurality of dependencies of the certificate to a certificate digest;
broadcasting a message to a peer-to-peer network communicatively linked to the plurality of subnetworks using a broadcast primitive, the message comprising the certificate and the certificate digest;
comparing the plurality of dependencies of the certificate in the certificate digest to a plurality of dependencies of the certificate in a certificate history;
validating, based on the comparison, the certificate; and
applying, based on the validation, the certificate digest to the certificate history.

2. The method of claim 1, wherein the broadcast primitive comprises a weak causal probabilistic reliable broadcast.

3. The method of claim 1, wherein the broadcast primitive comprises echo messaging.

4. The method of claim 1, further comprising, prior to the comparison and the validation, adding the certificate to a certificate pool.

5. The method of claim 1, wherein the substantially causal ordering comprises a weak causal ordering.

6. The method of claim 1, further comprising registering a node from the plurality of subnetworks to the peer-to-peer network.

7. The method of claim 1, further comprising:
storing a hash of certificates in the certificate history; and
storing a hash of certificates in the certificate digest.

8. A non-transitory computer readable storage medium comprising stored instructions, the instructions when executed by a processor cause the processor to:
receive, from a subnetwork of a plurality of subnetworks, a certificate comprising a plurality of dependencies specifying a substantially causal ordering of the certificate;
apply the certificate and the plurality of dependencies of the certificate to a certificate digest;
broadcast a message to a peer-to-peer network communicatively linked to the plurality of subnetworks using a broadcast primitive, the message comprising the certificate and the certificate digest;
compare the plurality of dependencies of the certificate in the certificate digest to a plurality of dependencies of the certificate in a certificate history;
validate, based on the comparison, the certificate; and
apply, based on the validation, the certificate digest to the certificate history.

9. The non-transitory computer-readable storage medium of claim 8, wherein the broadcast primitive comprises a weak causal probabilistic reliable broadcast.

10. The non-transitory computer-readable storage medium of claim 8, wherein the broadcast primitive comprises echo messaging.

11. The non-transitory computer-readable storage medium of claim 8, wherein the instructions further cause the processor to, prior to the comparison and the validation, add the certificate to a certificate pool.

12. The non-transitory computer-readable storage medium of claim 8, wherein the substantially causal ordering comprises a weak causal ordering.

13. The non-transitory computer-readable storage medium of claim 8, wherein the instructions further cause the processor to register a node from the plurality of subnetworks to the peer-to-peer network.

14. The non-transitory computer-readable storage medium of claim 8, wherein the instructions further cause the processor to:
store a hash of certificates in the certificate history; and
store a hash of certificates in the certificate digest.

15. A system comprising:
one or more processors; and
a non-transitory computer-readable medium comprising stored instructions, the instructions when executed by the one or more processors cause the one or more processors to:
receive, from a subnetwork of a plurality of subnetworks, a certificate comprising a plurality of dependencies specifying a substantially causal ordering of the certificate;
apply the certificate and the plurality of dependencies of the certificate to a certificate digest;
broadcast a message to a peer-to-peer network communicatively linked to the plurality of subnetworks using a broadcast primitive, the message comprising the certificate and the certificate digest;
compare the plurality of dependencies of the certificate in the certificate digest to a plurality of dependencies of the certificate in a certificate history;
validate, based on the comparison, the certificate; and
apply, based on the validation, the certificate digest to the certificate history.

16. The system of claim 15, wherein the broadcast primitive comprises a weak causal probabilistic reliable broadcast.

17. The system of claim 15, wherein the broadcast primitive comprises echo messaging.

18. The system of claim 15, wherein the instructions further cause the processor to, prior to the comparison and the validation, add the certificate to a certificate pool.

19. The system of claim 15, wherein the substantially causal ordering comprises a weak causal ordering.

20. The system of claim 15, wherein the instructions further cause the processor to:
store a hash of certificates in the certificate history; and
store a hash of certificates in the certificate digest.
